(19) United States
(12) Patent Application Publication
(10) Pub. No.: US 2016/0323126 A1
(43) Pub. Date: Nov. 3, 2016

(54) WIRELESS DEVICE AND DATA TRANSFER METHOD

(71) Applicant: FUJITSU LIMITED, Kawasaki-shi (JP)

(72) Inventors: Noboru MASUDA, Sagamihara (JP); Junya MORITA, Yokohama (JP); Kenji IWAI, Sapporo (JP)

(73) Assignee: FUJITSU LIMITED, Kawasaki-shi (JP)

(21) Appl. No.: 15/081,920

(22) Filed: Mar. 27, 2016

(30) Foreign Application Priority Data
May 1, 2015 (JP) 2015-094105

(51) Int. Cl. H04L 25/14; H04W 88/08; H04L 25/02

(52) U.S. Cl. CPC H04L 25/14; H04L 25/0222; H04W 88/08

(57) ABSTRACT

A wireless device includes a processor that includes a first interface for transmitting and receiving data, a second interface that transfers data to and from the first interface, and a memory connected to the processor. The processor executes a process including acquiring carrier bandwidth information on baseband data used for wireless communication, calculating a needed data rate for transferring the baseband data between the first interface and the second interface, based on the acquired carrier bandwidth information, determining number of transfer paths for simultaneously transferring the baseband data between the first interface and the second interface, based on the calculated needed data rate, and causing the first interface and the second interface to transmit and receive the baseband data by simultaneously using the determined number of transfer paths.

### CROSS-REFERENCE TO RELATED APPLICATION

This application is based upon and claims the benefit of priority of the prior Japanese Patent Application No. 2015-094105, filed on May 1, 2015, the entire contents of which are incorporated herein by reference.

### FIELD

The embodiments discussed herein are related to a wireless device and a data transfer method.

### BACKGROUND

In recent years, in a wireless communication system, carrier aggregation (CA) standardized by 3rd Generation Partnership Project (3GPP) is sometimes employed. In a wireless communication system employing the CA, a base station device and a terminal device perform wireless communication by using a plurality of carriers with different frequency bands. The number of the carriers used for the wireless communication may dynamically be changed depending on, for example, a desired data transfer speed or the like. That is, the base station device and the terminal device need not always use a carrier group with the same bandwidth, but the bandwidth used for the wireless communication may be changed in some cases.

In the wireless communication system employing the CA as described above, a study is in progress to independently provide a baseband processing unit and a wireless processing unit of the base station device as separate bodies. That is, a study is in progress to connect the baseband processing unit and the wireless processing unit of the base station device by, for example, an optical fiber, and cause a device corresponding to the wireless processing unit (hereinafter, referred to as a “wireless device”) to transmit and receive a wireless signal. With this configuration, it becomes possible to connect a plurality of wireless devices to a single device corresponding to the baseband processing unit (hereinafter, referred to as a “baseband processing device”), and reduce costs due to expansion of a wireless communication area.

The wireless device connected to the baseband processing device includes a first chip provided with a processor, such as a field programmable gate array (FPGA) or a central processing unit (CPU), and a second chip provided with a digital-to-analog (DA) converter, an amplifier, and the like. The chips are connected by a plurality of lanes serving as data transfer paths, and transfer data through the plurality of the lanes. Specifically, when transmission data is transferred from the first chip to the second chip for example, the transmission data is transferred in parallel through a plurality of lanes that connect data transmission interfaces of the respective chips.
Patent Document 1: Japanese Laid-open Patent Publication No. 2014-78065
Patent Document 2: Japanese Laid-open Patent Publication No. 2009-59122
Patent Document 3: Japanese Laid-open Patent Publication No. 2014-78895

However, the number of the lanes that connect the chips and that operate corresponds to the maximum data rate available for transfer, so that power consumption is increased. That is, for example, the number of the lanes that operate among the lanes connecting the interfaces for transmission data corresponds to the expected maximum data rate of the transmission data. Therefore, if the data rate of the transmission data is low, some of the lanes may be operated wastefully.

In particular, in the CA, a bandwidth used for the wireless communication may be changed, and the data rate may increase or decrease with a change in the bandwidth. Even if the data rate increases or decreases as described above, the number of the lanes between the chips of the wireless device is constant; therefore, power is wasted when the data rate is low.

The wasting of the power as described above may occur not only between the interfaces for transmission data, but also, for example, between interfaces for a feedback signal to perform distortion compensation or between interfaces for uplink reception data in the same manner.

### SUMMARY

According to an aspect of an embodiment, a wireless device includes: a processor that includes a first interface for transmitting and receiving data; a second interface that transfers data to and from the first interface; and a memory connected to the processor. The processor executes a process including: acquiring carrier bandwidth information on baseband data used for wireless communication; calculating a needed data rate for transferring the baseband data between the first interface and the second interface, based on the acquired carrier bandwidth information; determining number of transfer paths for simultaneously transferring the baseband data between the first interface and the second interface, based on the calculated needed data rate; and causing the first interface and the second interface to transmit and receive the baseband data by simultaneously using the determined number of transfer paths.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of a wireless communication system according to a first embodiment;

FIG. 2 is a block diagram illustrating a configuration of a wireless device according to the first embodiment;

FIG. 3 is a block diagram illustrating a configuration of a processor according to the first embodiment;

FIG. 4 is a flowchart illustrating a process at the time of transmitting data according to the first embodiment;

FIG. 5 is a diagram illustrating a concrete example of a relationship between I/F setting and a data rate;

FIG. 6 is a diagram illustrating a concrete example of an interpolation rate and a decimation rate;

FIG. 7 is a diagram for explaining frequency shift;

FIG. 8 is a flowchart illustrating a process at the time of receiving data according to the first embodiment;

FIG. 9 is a diagram illustrating a concrete example of the decimation rate;

FIG. 10 is a block diagram illustrating a processor according to a modification of the first embodiment;

FIG. 11 is a block diagram illustrating a configuration of a wireless device according to a second embodiment;

FIG. 12 is a block diagram illustrating a configuration of a processor according to the second embodiment; and

FIG. 13 is a flowchart illustrating a process at the time of transmitting data according to the second embodiment.

### DESCRIPTION OF EMBODIMENT(S)

Preferred embodiments of the present invention will be explained with reference to accompanying drawings. The disclosed technology is not limited by the embodiments below.

### [a] First Embodiment

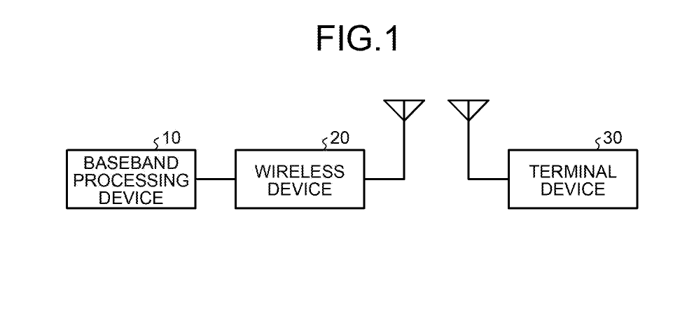

FIG. 1 is a diagram illustrating a configuration of a wireless communication system according to a first embodiment. The wireless communication system illustrated in FIG. 1 includes a baseband processing device 10, a wireless device 20, and a terminal device 30.

The baseband processing device 10 may be referred to as a base band unit (BBU) or the like, and performs baseband processing on transmission data and reception data. Specifically, the baseband processing device 10 performs, for example, encoding and modulation on transmission data, and performs demodulation and decoding on reception data. The data processed by the baseband processing device 10 is baseband data. Therefore, the baseband processing device 10 transmits baseband transmission data to the wireless device 20, and receives baseband reception data from the wireless device 20.

The wireless device 20 may be referred to as a remote radio head (RRH) or the like, and performs transmission and reception of a wireless signal. Specifically, the wireless device 20 is connected to the baseband processing device 10 via, for example, an optical fiber, and wirelessly transmits transmission data received from the baseband processing device 10 through an antenna. Furthermore, the wireless device 20 transmits reception data received through the antenna to the baseband processing device 10.

The wireless device 20 includes a chip provided with a processor, such as an FPGA, that performs distortion compensation or the like on transmission data, and includes a chip provided with a component that performs DA conversion, modulation, or the like on the transmission data. Each of the chips includes an interface, and the interfaces are connected to each other by a plurality of lanes that serve as data transfer paths in order to perform inter-chip communication. A specific configuration of the wireless device 20 will be described in detail later.

The terminal device 30 is a wireless communication terminal, such as a mobile phone or a smartphone, and performs wireless communication with the wireless device 20. Specifically, the terminal device 30 transmits a wireless signal to the wireless device 20 through an antenna and receives a wireless signal transmitted from the wireless device 20 through the antenna.

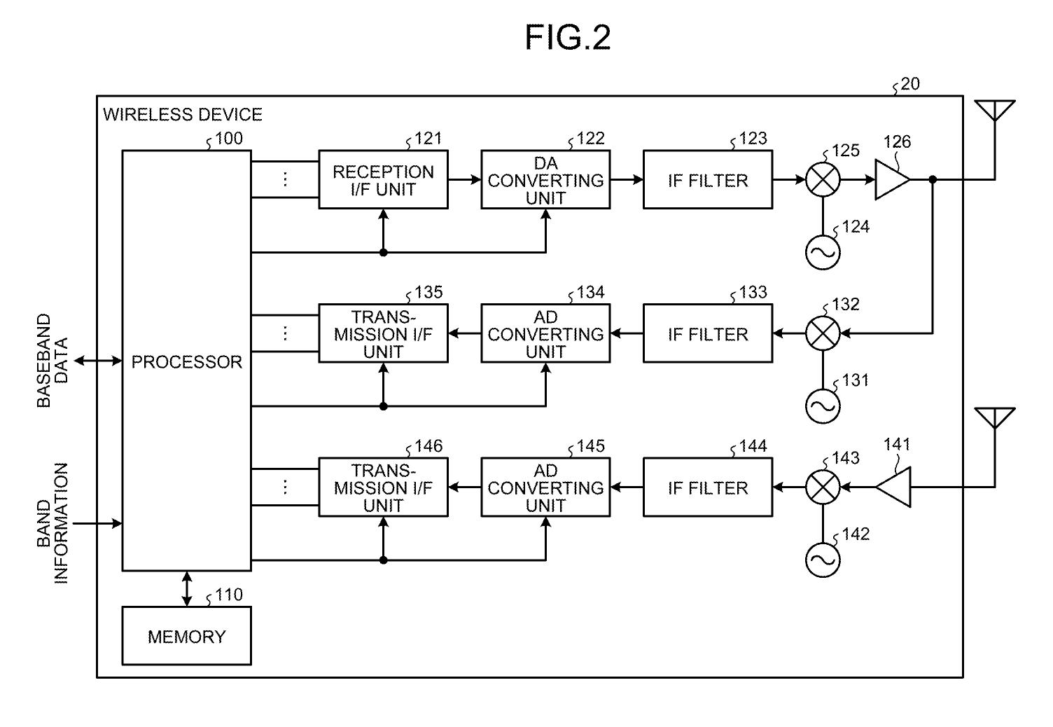

FIG. 2 is a block diagram illustrating a configuration of the wireless device 20 according to the first embodiment. The wireless device 20 illustrated in FIG. 2 includes a chip provided with a processor 100 and a memory 110. Furthermore, the wireless device 20 includes, in a data transmission system, a reception interface unit (hereinafter, described as a “reception I/F unit”) 121, a DA converting unit 122, an intermediate frequency (IF) filter 123, an oscillator 124, a mixer 125, and an amplifier 126. Moreover, the wireless device 20 includes, in a data feedback system, an oscillator 131, a mixer 132, an IF filter 133, an analog-to-digital (AD) converting unit 134, and a transmission interface unit (hereinafter, described as a “transmission I/F unit”) 135. Furthermore, the wireless device 20 includes, in a data reception system, an amplifier 141, an oscillator 142, a mixer 143, an IF filter 144, an AD converting unit 145, and a transmission I/F unit 146. The transmission system, the feedback system, and the reception system may be mounted on a single chip.

The processor 100 transmits and receives baseband data to and from the baseband processing device 10. Specifically, the processor 100 receives baseband transmission data from the baseband processing device 10, performs distortion compensation on the transmission data, and then sends the transmission data to the reception I/F unit 121. Furthermore, the processor 100 receives, from the transmission I/F unit 135, baseband feedback data that is fed back by the feedback system. The processor 100 updates a coefficient for distortion compensation or the like by using the feedback data. Furthermore, the processor 100 receives, from the transmission I/F unit 146, baseband reception data subjected to a reception process by the reception system, and transmits the reception data to the baseband processing device 10.

Moreover, the processor 100 acquires carrier bandwidth information on each of the transmission data and the reception data, and calculates a data rate of each of the transmission data and the reception data from the carrier bandwidth information. Then, the processor 100 controls the number of lanes between the processor 100 and each of the reception I/F unit 121, the transmission I/F unit 135, and the transmission I/F unit 146 and the data rate of each of the lanes in accordance with the data rates. Furthermore, the processor 100 controls an interpolation rate in the DA converting unit 122 and a decimation rate in the AD converting unit 134 and the AD converting unit 145 in accordance with the controlled number of lanes and the controlled data rates of the respective lanes. Specific operation of the processor 100 will be described in detail later.

The memory 110 stores therein information or the like used for a process performed by the processor 100. Specifically, the memory 110 stores therein, for example, a table or the like indicating a correspondence relationship among a coefficient for distortion compensation on transmission data, a data rate, an interpolation rate, and a decimation rate.

The components of the transmission system will be described below. The transmission system performs a predetermined wireless transmission process on transmission data.

The reception I/F unit 121 is connected to the processor 100 by a plurality of lanes, and receives transmission data that is transferred in parallel by the lanes. At this time, the reception I/F unit 121 operates a certain number of lanes designated by the processor 100, and receives the transmission data transferred by the operating lanes. Then, the reception I/F unit 121 converts the transmission data that is transferred in parallel into serial data, and outputs the serial data to the DA converting unit 122.

The DA converting unit 122 performs DA conversion on the transmission data output from the reception I/F unit 121, and outputs transmission data at an intermediate frequency (IF) to the IF filter 123. At this time, the DA converting unit 122 performs the DA conversion while interpolating the transmission data at an interpolation rate designated by the processor 100, thereby maintaining a sampling frequency constant. In the following, an example will be described in which a zero intermediate frequency (ZIF) scheme is used as an IF scheme. Therefore, the IF is equal to a baseband frequency. However, the disclosed technology is applicable to a case in which a complex intermediate frequency (CIF) scheme is used as the IF scheme.

The IF filter 123 is a filter that has a predetermined pass band to pass the transmission data output from the DA converting unit 122 and to remove an image component. Specifically, the IF filter 123 passes a band lower than a half of the sampling frequency in the DA converting unit 122, and removes an image component that is generated in a band equal to or higher than the half of the sampling frequency.

The oscillator 124 generates a local signal for performing up-conversion on the transmission data at the IF to transmission data at a radio frequency (RF).

The mixer 125 performs up-conversion on the transmission data at the IF to transmission data at an RF by using the local signal generated by the oscillator 124.

The amplifier 126 amplifies the transmission data subjected to the up-conversion, and wirelessly transmits the transmission data through an antenna.

The components of the feedback system will be described below. The feedback system feeds transmission data to the processor 100 for distortion compensation.

The oscillator 131 generates a local signal for performing down-conversion on the transmission data at the RF to transmission data at an IF.

The mixer 132 performs down-conversion on feedback data, which is the fed-back transmission data at the RF, by using the local signal generated by the oscillator 131.

The IF filter 133 is a low pass filter that passes the feedback data and removes folding noise.

The AD converting unit 134 performs AD conversion on the feedback data output from the IF filter 133, and outputs baseband feedback data to the transmission I/F unit 135. At this time, the AD converting unit 134 performs the AD conversion while decimating the feedback data at a decimation rate designated by the processor 100, thereby maintaining a sampling frequency constant.

The transmission I/F unit 135 is connected to the processor 100 by a plurality of lanes, and transmits the feedback data in parallel by the lanes. At this time, the transmission I/F unit 135 operates a certain number of lanes designated by the processor 100, and transmits the feedback data in parallel by the operating lanes. Furthermore, the transmission I/F unit 135 sets a data rate of each of the operating lanes to a data rate designated by the processor 100.

The components of the reception system will be described below. The reception system performs a predetermined wireless reception process on reception data.

The amplifier 141 amplifies reception data received through an antenna, and outputs the reception data to the mixer 143.

The oscillator 142 generates a local signal for performing down-conversion on reception data at an RF to reception data at an IF.

The mixer 143 performs down-conversion on the reception data at the RF to reception data at an IF by using the local signal generated by the oscillator 142.

The IF filter 144 is a low pass filter that passes the reception data and removes folding noise.

The AD converting unit 145 performs AD conversion on the reception data output from the IF filter 144, and outputs baseband reception data to the transmission I/F unit 146. At this time, the AD converting unit 145 performs the AD conversion while decimating the reception data at the decimation rate designated by the processor 100, thereby maintaining the sampling frequency constant.

The transmission I/F unit 146 is connected to the processor 100 by a plurality of lanes, and transmits the reception data in parallel by the lanes. At this time, the transmission I/F unit 146 operates a certain number of lanes designated by the processor 100, and transmits the reception data in parallel by the operating lanes. Furthermore, the transmission I/F unit 146 sets a data rate of each of the operating lanes to a data rate designated by the processor 100.

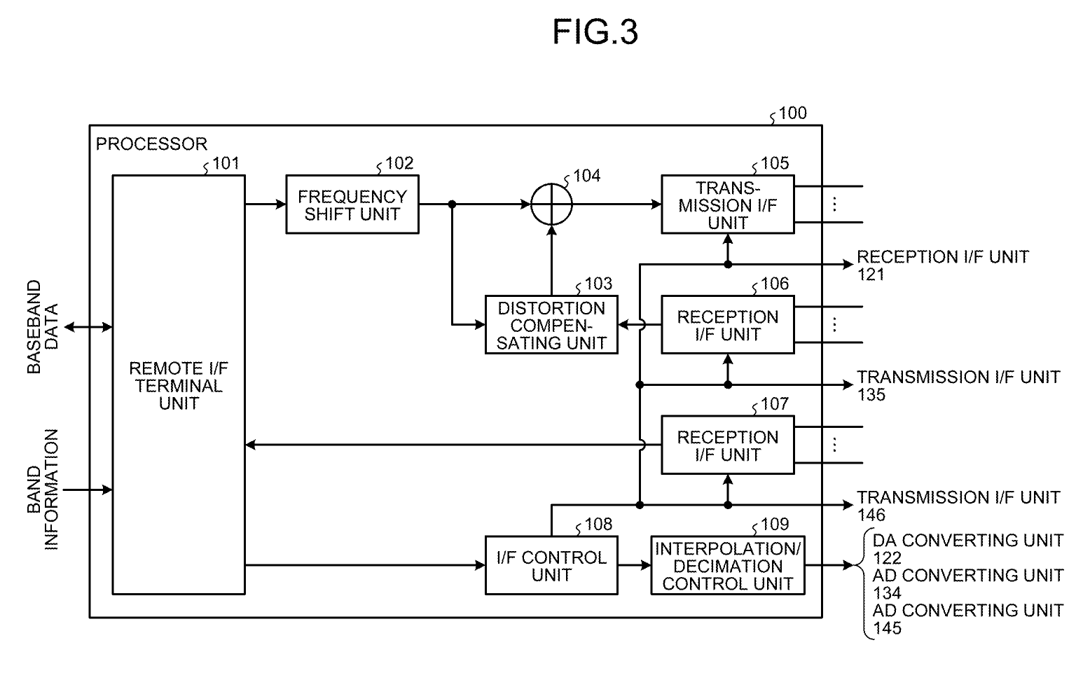

FIG. 3 is a block diagram illustrating a configuration of the processor 100 according to the first embodiment. The processor 100 illustrated in FIG. 3 includes a remote interface terminal unit (hereinafter, described as a “remote I/F terminal unit”) 101, a frequency shift unit 102, a distortion compensating unit 103, a synthesizing unit 104, a transmission I/F unit 105, a reception I/F unit 106, a reception I/F unit 107, an I/F control unit 108, and an interpolation/decimation control unit 109.

The remote I/F terminal unit 101 is connected to the baseband processing device 10, and transmits and receives baseband data to and from the baseband processing device 10. Specifically, the remote I/F terminal unit 101 outputs baseband transmission data received from the baseband processing device 10, and outputs the transmission data to the frequency shift unit 102. Furthermore, the remote I/F terminal unit 101 acquires baseband reception data from the reception I/F unit 107, and transmits the reception data to the baseband processing device 10. Moreover, the remote I/F terminal unit 101 receives carrier bandwidth information indicating spectrum widths of the transmission data and the reception data from the baseband processing device 10, and notifies the frequency shift unit 102 and the I/F control unit 108 of the carrier bandwidth information.

The frequency shift unit 102 performs frequency shift on the transmission data on the basis of the carrier bandwidth information provided by the remote I/F terminal unit 101. Specifically, the frequency shift unit 102 performs the frequency shift such that the center frequency of the entire band of the transmission data becomes 0 Hz. Specifically, in a wireless communication system using the CA for example, the number of carriers for transmitting data is not always constant but is changed, so that the total spectrum width of the baseband transmission data is not constant. Therefore, the frequency shift unit 102 performs the frequency shift so that the center frequency of the total of all transmission spectrums actually used by the transmission data becomes 0 Hz such that the total of the transmission spectrums becomes symmetric with respect to 0 Hz on the frequency axis. Incidentally, the center frequency is an average frequency of the minimum frequency and the maximum frequency of the entire band of the transmission spectrums.

The distortion compensating unit 103 selects a distortion compensation coefficient corresponding to a level of the transmission data, and outputs the distortion compensation coefficient to the synthesizing unit 104. The distortion compensation coefficient selected by the distortion compensating unit 103 corresponds to a distortion component that cancels out intermodulation distortion that occurs in the amplifier 126. Furthermore, the distortion compensating unit 103 acquires feedback data from the reception I/F unit 106, and updates the distortion compensation coefficient so as to reduce an error between the transmission data and the feedback data.

The synthesizing unit 104 synthesizes the distortion compensation coefficient output from the distortion compensating unit 103 and the transmission data, and distorts the transmission data in advance. When the amplifier 126 amplifies the transmission data, intermodulation distortion is given to the transmission data; however, by distorting the transmission data in advance, the intermodulation distortion can be cancelled out.

The transmission I/F unit 105 is connected to the reception I/F unit 121 by a plurality of lanes, and transmits the transmission data, which is subjected to the distortion compensation, in parallel by the lanes. At this time, the transmission I/F unit 105 operates a certain number of lanes designated by the I/F control unit 108, performs parallel conversion on the transmission data into a certain number of series of transmission data equal to the number of the operating lanes, and transmits the transmission data in parallel. Furthermore, the transmission I/F unit 105 sets a data rate of each of the operating lanes to a data rate designated by the I/F control unit 108.

The reception I/F unit 106 is connected to the transmission I/F unit 135 by a plurality of lanes, and receives feedback data in parallel by the lanes. At this time, the reception I/F unit 106 operates a certain number of lanes designated by the I/F control unit 108, and receives the feedback data in parallel by the operating lanes. The reception I/F unit 106 outputs the received feedback data to the distortion compensating unit 103.

The reception I/F unit 107 is connected to the transmission I/F unit 146 by a plurality of lanes, and receives reception data in parallel by the lanes. At this time, the reception I/F unit 107 operates a certain number of lanes designated by the I/F control unit 108, and receives the reception data in parallel by the operating lanes. The reception I/F unit 107 outputs the received reception data to the remote I/F terminal unit 101.

The I/F control unit 108, when notified of the carrier bandwidth information by the remote I/F terminal unit 101, calculates needed data rates of the transmission data, the feedback data, and the reception data. Specifically, if the bandwidth of the transmission data is, for example, 60 MHz, and if distortion outside the bandwidth is not taken into account, the I/F control unit 108 calculates the needed data rate of the transmission data as 60 Mega samples per second (Msps) equal to the bandwidth. Furthermore, if first-order to third-order distortions are taken into account as targets for distortion compensation, the I/F control unit 108 calculates the needed data rate of the transmission data as 180 (=60×3) Msps. Similarly, if first-order to fifth-order distortions are taken into account as targets for distortion compensation, the I/F control unit 108 calculates the needed data rate of the transmission data as 300 (=60×5) Msps.

The I/F control unit 108 calculates the needed data rate of the feedback data in the same manner as the needed data rate of the transmission data. Specifically, the I/F control unit 108 calculates, as the needed data rate of the feedback data, a data rate equal to an odd multiple of the bandwidth of the transmission data in accordance with the order of distortions as targets for distortion compensation. Furthermore, if the bandwidth of the reception data is, for example, 60 MHz, the I/F control unit 108 calculates the needed data rate of the reception data as 60 Msps.

Then, upon calculating the needed data rates of the transmission data, the feedback data, and the reception data, the I/F control unit 108 determines the number of lanes between the interfaces and a data rate of each of the lanes so as to satisfy the needed data rates. Specifically, the I/F control unit 108 determines the number of lanes simultaneously used between the transmission I/F unit 105 and the reception I/F unit 121 and the data rate of each of the lanes, on the basis of the needed data rate of the transmission data. Furthermore, the I/F control unit 108 determines the number of lanes simultaneously used between the transmission I/F unit 135 and the reception I/F unit 106 and the data rate of each of the lanes, on the basis of the needed data rate of the feedback data. Moreover, the I/F control unit 108 determines the number of lanes simultaneously used between the transmission I/F unit 146 and the reception I/F unit 107 and the data rate of each of the lanes, on the basis of the needed data rate of the reception data.

The I/F control unit 108, upon determining the number of lanes simultaneously used between the interfaces and the data rate of each of the lanes, provides the determined number of lanes and the determined data rate of each of the lanes to each of the interfaces.

The interpolation/decimation control unit 109 determines an interpolation rate and a decimation rate for DA conversion and AD conversion, in accordance with the number of lanes simultaneously used between the interfaces and a total data rate obtained from the data rates of all of the lanes. Specifically, although the total data rate for transfer between the interfaces is changed when the I/F control unit 108 changes the number of operating lanes or the like, the interpolation/decimation control unit 109 determines the interpolation rate and the decimation rate such that the data rate appears to be constant.

Therefore, for example, if the needed data rate of the transmission data is large and the total data rate between the interfaces is large, the interpolation/decimation control unit 109 reduces the interpolation rate in the DA converting unit 122 in order to prevent interpolation from being performed a number of times. In contrast, for example, if the needed data rate of the transmission data is small and the total data rate between the interfaces is small, the interpolation/decimation control unit 109 increases the interpolation rate in the DA converting unit 122 in order to perform interpolation a number of times.

Similarly, for example, if the needed data rate of the reception data is large and the total data rate between the interfaces is large, the decimation rate in the AD converting unit 145 is increased in order to prevent decimation from being performed a number of times. Furthermore, for example, if the needed data rate of the reception data is small and the total data rate between the interfaces is small, the decimation rate in the AD converting unit 145 is reduced in order to perform decimation a number of times.

The interpolation/decimation control unit 109 provides each of the determined interpolation rate and the determined decimation rate to the DA converting unit 122, the AD converting unit 134, or the AD converting unit 145, and maintains sampling frequencies for DA conversion and AD conversion constant.

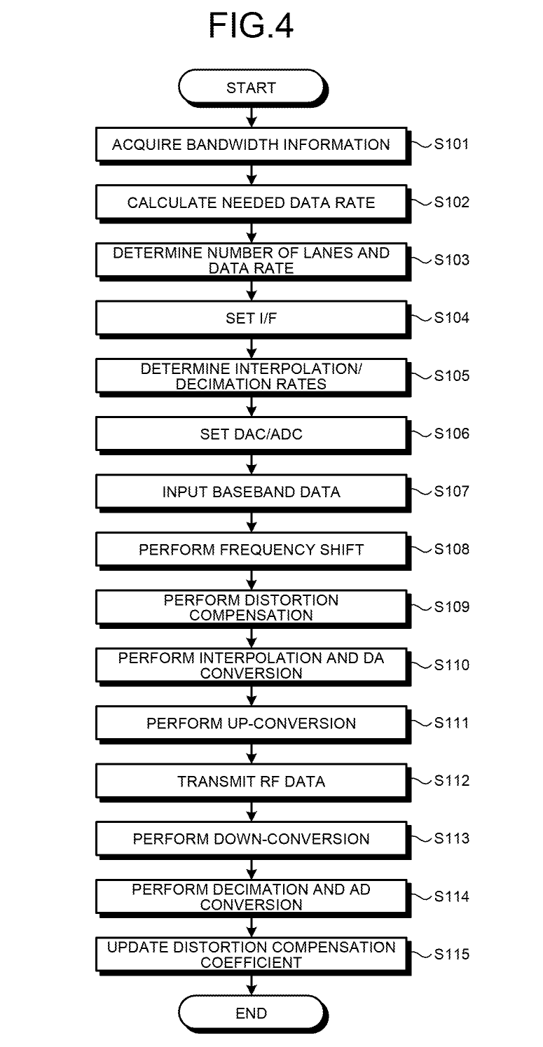

A process performed by the wireless device 20 with the above-described configuration at the time of transmitting data will be described below with a concrete example, with reference to a flowchart in FIG. 4.

The wireless device 20 receives carrier bandwidth information indicating the spectrum width of transmission data from the baseband processing device 10. The remote I/F terminal unit 101 of the processor 100 acquires the carrier bandwidth information (Step S101). The carrier bandwidth information is output to the I/F control unit 108, and the I/F control unit 108 calculates needed data rates of the transmission data and feedback data (Step S102). Specifically, the needed data rates of the transmission data and the feedback data are calculated based on the bandwidth of the transmission data. That is, if the bandwidth of the transmission data is, for example, 60 MHz, and if distortion outside the bandwidth is not taken into account, the needed data rate of each of the transmission data and the feedback data is calculated as 60 Msps. Furthermore, if the bandwidth of the transmission data is, for example, 60 MHz, and if first-order to third-order distortions are taken into account as targets for distortion compensation, the needed data rate of each of the transmission data and the feedback data is calculated as 180 (=60×3) Msps.

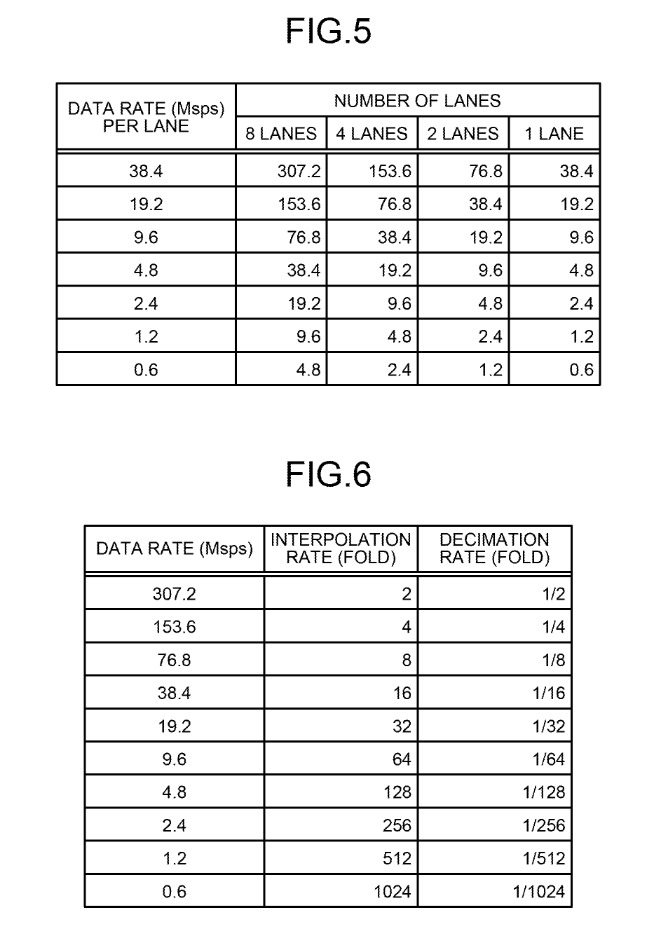

Upon calculating the needed data rates, the I/F control unit 108 determines the number of lanes between the interfaces and a data rate of each of the lanes so as to satisfy the needed data rates (Step S103). Specifically, for example, a table illustrated in FIG. 5 is referred to, and the number of lanes and a data rate per lane for realizing a data rate equal to or higher than the needed data rates. For example, when a needed data rate is 150 Msps, and if the number of lanes is eight and the data rate per lane is 19.2 Msps or 38.4 Msps, the data rate become 153.6 Msps or 307.2 Msps, which satisfies the needed data rate. Furthermore, if the number of lanes is four and the data rate per lane is 38.4 Msps, the data rate becomes 153.6 Msps, which satisfies the needed data rate.

Incidentally, to reduce power consumption, it is preferable to reduce the number of lanes or the data rate per lane. Therefore, the I/F control unit 108 selects 153.6 Msps that is the minimum data rate that satisfies the needed data rate of 150 Msps from the table illustrated in FIG. 5, and acquires a combination of the corresponding number of lanes and a corresponding data rate per lane. In this example, a combination of 8 lanes and 19.2 Msps and a combination of 4 lanes and 38.4 Msps are available, and any of the combinations is acquired. At this time, if priority is given to a reduction in the number of lanes from the viewpoint of power consumption, the combination of 4 lanes and 38.4 Msps is acquired, and if priority is given to a reduction in the data rate per lane, the combination of 8 lanes and 19.2 Msps is acquired.

Then, the number of lanes and the data rate per lane acquired as above are set in each of the interfaces (Step S104). Specifically, the I/F control unit 108 sets the number of lanes and the data rate for transmission data between the transmission I/F unit 105 and the reception I/F unit 121, and the number of lanes and the data rate for feedback data between the transmission I/F unit 135 and the reception I/F unit 106.

Furthermore, the interpolation/decimation control unit 109 determines an interpolation rate in the DA converting unit 122 and a decimation rate in the AD converting unit 134, from a data rate corresponding to the combination of the number of lanes and the data rate per lane (Step S105). Specifically, for example, a table illustrated in FIG. 6 is referred to, and an interpolation rate and a decimation rate are determined so as to correspond to the data rate obtained by the number of lanes and the data rate per lane that are determined by the I/F control unit 108. For example, if the data rate between the transmission I/F unit 105 and the reception I/F unit 121 is set to 153.6 Msps, the interpolation/decimation control unit 109 determines that the interpolation rate in the DA converting unit 122 is quadruple. Furthermore, if the data rate between the transmission I/F unit 135 and the reception I/F unit 106 is set to 153.6 Msps, the interpolation/decimation control unit 109 determines that the decimation rate in the AD converting unit 134 is one-fourth.

Then, the interpolation/decimation control unit 109 sets the determined interpolation rate in the DA converting unit 122 and sets the decimation rate in the AD converting unit 134 (Step S106). As described above, the interpolation rate for DA conversion and the decimation rate for AD conversion are determined in accordance with the data rates between the interfaces, so that the sampling frequencies in the DA converting unit 122 and the AD converting unit 134 can be maintained constant.

Then, in the state in which the number of lanes between the interfaces, the data rate per lane, the interpolation rate for DA conversion, and the decimation rate for AD conversion are set, baseband transmission data is input to the remote I/F terminal unit 101 of the processor 100 (Step S107). The remote I/F terminal unit 101 outputs the transmission data to the frequency shift unit 102, and the frequency shift unit 102 performs frequency shift such that the center frequency becomes 0 Hz (Step S108).

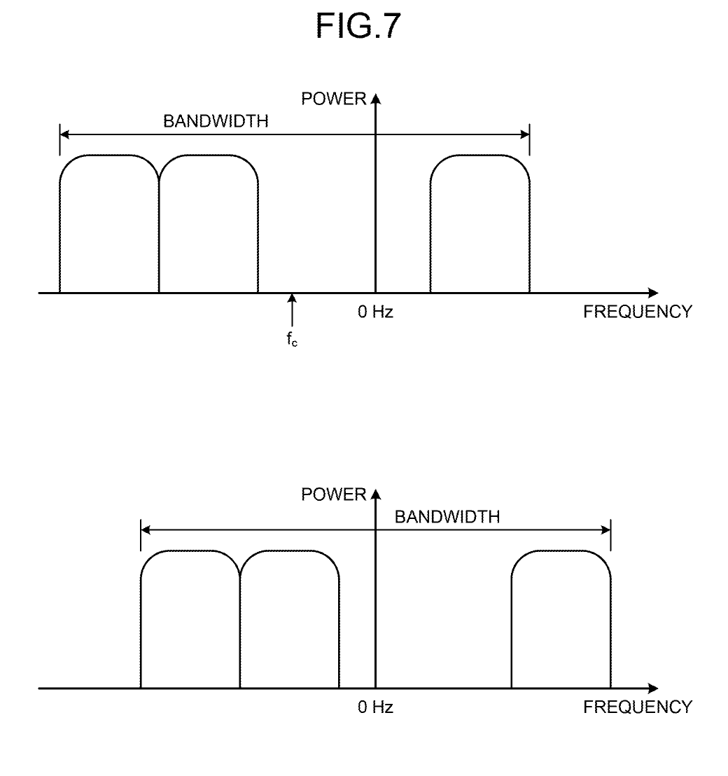

Specifically, the frequency shift unit 102 acquires the carrier bandwidth information on the transmission data, and performs the frequency shift such that an average of the maximum frequency and the minimum frequency of the transmission data is set to 0 Hz. Therefore, for example, in the entire bandwidth of a plurality of carriers of the transmission data, if a center frequency f_{c} is not equal to 0 Hz as illustrated in an upper part of FIG. 7, the frequency of each of the carriers is shifted such that the center frequency becomes 0 Hz as illustrated in a lower part of FIG. 7. By performing the frequency shift as described above, the bandwidth of the transmission data becomes symmetric with respect to 0 Hz, and a total data rate between the transmission I/F unit 105 and the reception I/F unit 121 can be adjusted to the minimum data rate equal to the bandwidth of the transmission data. As a result, it is possible to minimize the number of lanes between the transmission I/F unit 105 and the reception I/F unit 121 and minimize the data rate per lane, enabling to reduce power consumption.

The synthesizing unit 104 performs distortion compensation on the transmission data subjected to the frequency shift (Step S109). Specifically, the distortion compensating unit 103 outputs a distortion compensation coefficient corresponding to a level of the transmission data to the synthesizing unit 104, and the synthesizing unit 104 adds distortion based on the distortion compensation coefficient to the transmission data. Then, the transmission I/F unit 105 converts the transmission data subjected to the distortion compensation into a certain number of series of parallel data corresponding to the number of lanes set by the I/F control unit 108, and transfers the transmission data to the reception I/F unit 121. At this time, the data rate of each of the lanes that operate between the transmission I/F unit 105 and the reception I/F unit 121 is the data rate set by the I/F control unit 108.

If the reception I/F unit 121 receives the transmission data, the reception I/F unit 121 converts the parallel transmission data into serial data, and outputs the transmission data to the DA converting unit 122. Then, the DA converting unit 122 performs interpolation and DA conversion on the transmission data (Step S110). The DA converting unit 122 performs the interpolation at the interpolation rate set by the interpolation/decimation control unit 109. Therefore, the sampling frequency for DA conversion performed by the DA converting unit 122 is maintained constant. That is, even if a total data rate between the transmission I/F unit 105 and the reception I/F unit 121 is changed, the sampling frequency in the DA converting unit 122 is not changed.

The transmission data subjected to the DA conversion passes through the IF filter 123, so that an image component is removed. The pass band of the IF filter 123 is fixed to a band lower than a half of the sampling frequency in the DA converting unit 122. However, because the sampling frequency in the DA converting unit 122 is constant, the image component can be removed with accuracy. Then, the mixer 125 performs up-conversion on the transmission data that has passed through the IF filter 123 (Step S111). Specifically, the mixer 125 converts the transmission data into data at an RF by using a local signal generated by the oscillator 124.

The transmission data at the RF obtained through the up-conversion is amplified by the amplifier 126, and then wirelessly transmitted from the antenna (Step S112). Intermodulation distortion that occurs in the amplifier 126 is cancelled out by the distortion that is added to the transmission data in advance by the synthesizing unit 104; therefore, it is possible to reduce out-of-band emission of a signal wirelessly transmitted from the antenna.

The transmission data wirelessly transmitted from the antenna serves as feedback data that is fed back for updating the distortion compensation coefficient. The mixer 132 performs down-conversion on the feedback data (Step S113). Specifically, the mixer 132 converts the feedback data into data at an IF by using a local signal generated by the oscillator 131.

The feedback data at the IF obtained through the down-conversion passes through the IF filter 133, so that occurrence of folding noise can be prevented. Then, the AD converting unit 134 performs decimation and AD conversion on the feedback data that has passed through the IF filter 133 (Step S114). The AD converting unit 134 performs the decimation at the decimation rate set by the interpolation/decimation control unit 109. Therefore, the sampling frequency for the AD conversion performed by the AD converting unit 134 is maintained constant. That is, even if a total data rate between the transmission I/F unit 135 and the reception I/F unit 106 in the subsequent stage is changed, the sampling frequency in the AD converting unit 134 is not changed.

The transmission I/F unit 135 converts the feedback data subjected to the AD conversion to a certain number of series of parallel data corresponding to the number of lanes set by the I/F control unit 108, and transfers the feedback data to the reception I/F unit 106. At this time, the data rate of each of the lanes that operate between the transmission I/F unit 135 and the reception I/F unit 106 is the data rate set by the I/F control unit 108.

If the reception I/F unit 106 receives the feedback data, the reception I/F unit 106 converts the parallel feedback data into serial data, and outputs the feedback data to the distortion compensating unit 103. Then, the distortion compensating unit 103 updates the distortion compensation coefficient so as to reduce an error between the transmission data and the feedback data (Step S115).

As described above, the number of lanes that operate between the interfaces for the transmission data and the feedback data and the data rate per lane are set in accordance with the bandwidth of the transmission data. Therefore, it is possible to reduce power consumption related to data transfer between the interfaces.

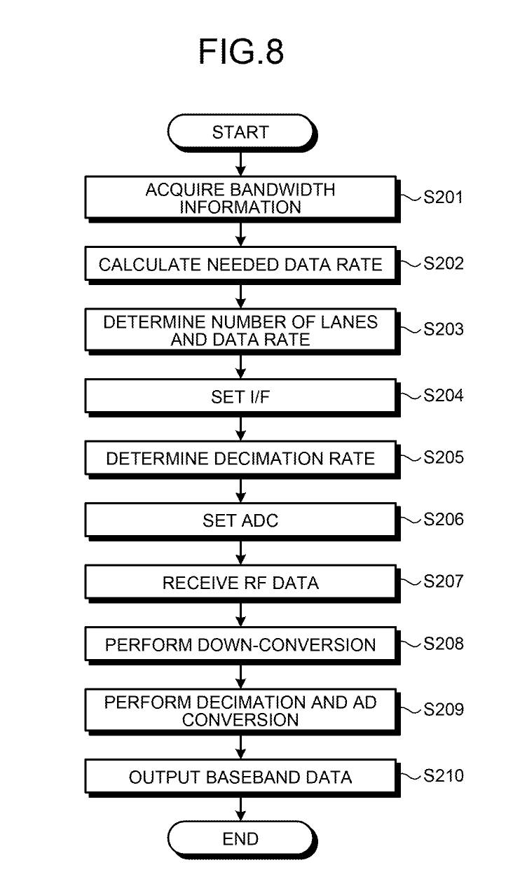

A process performed by the wireless device 20 at the time of receiving data will be described below with a concrete example, with reference to a flowchart illustrated in FIG. 8.

The wireless device 20 receives carrier bandwidth information indicating a band of reception data from the baseband processing device 10. The carrier bandwidth information is acquired by the remote I/F terminal unit 101 of the processor 100 (Step S201). The carrier bandwidth information is output to the I/F control unit 108, and the I/F control unit 108 calculates a needed data rate of the reception data (Step S202). Specifically, the needed data rate of the reception data is calculated based on the bandwidth of the reception data. That is, if the bandwidth of the reception data is, for example, 60 MHz, the needed data rate of the reception data is calculated as 60 Msps.

Upon calculating the needed data rate, the I/F control unit 108 determines the number of lanes between the interfaces and a data rate of each of the lanes so as to satisfy the needed data rate (Step S203). Specifically, for example, the table illustrated in FIG. 5 is referred to, and the number of lanes and a data rate per lane for realizing a data rate equal to or higher than the needed data rate. At this time, to reduce power consumption, it is preferable to reduce the number of lanes or the data rate per lane. Therefore, the I/F control unit 108 acquires a combination of the number of lanes and a data rate per lane corresponding to the minimum data rate that satisfies the needed data rate.

Then, the number of lanes and the data rate per lane acquired as above are set in each of the interfaces (Step S204). Specifically, the I/F control unit 108 sets the number of lanes and the data rate for reception data between the transmission I/F unit 146 and the reception I/F unit 107.

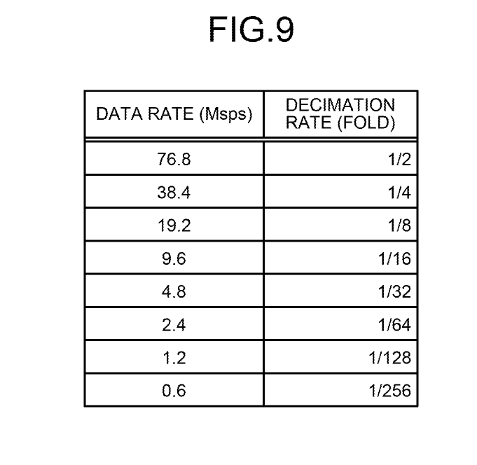

Furthermore, the interpolation/decimation control unit 109 determines a decimation rate in the AD converting unit 145 from a data rate corresponding to the combination of the number of lanes and the data rate per lane (Step S205). Specifically, for example, a table illustrated in FIG. 9 is referred to, and a decimation rate is determined so as to correspond to the data rate obtained by the number of lanes and the data rate per lane that are determined by the I/F control unit 108. For example, if the data rate between the transmission I/F unit 146 and the reception I/F unit 107 is set to 38.4 Msps, the interpolation/decimation control unit 109 determines that the decimation rate in the AD converting unit 145 is one-fourth.

Then, the interpolation/decimation control unit 109 sets the determined decimation rate in the AD converting unit 145 (Step S206). As described above, the decimation rate for AD conversion is set in accordance with the data rate between the interfaces, so that the sampling frequency in the AD converting unit 145 can be maintained constant.

Then, in the state in which the number of lanes between the interfaces, the data rate per lane, and the decimation rate for AD conversion are set, reception data at an RF is received through the antenna (Step S207). The amplifier 141 amplifies the reception data, and the mixer 143 performs down-conversion on the reception data (Step S208). That is, the mixer 143 converts the reception data into data at an IF by using a local signal generated by the oscillator 142.

The reception data at the IF obtained through the down-conversion passes through the IF filter 144, so that occurrence of folding noise can be prevented. Then, the AD converting unit 145 performs decimation and AD conversion on the reception data that has passed through the IF filter 144 (Step S209). The AD converting unit 145 performs the decimation at the decimation rate set by the interpolation/decimation control unit 109. Therefore, the sampling frequency for the AD conversion performed by the AD converting unit 145 is maintained constant. That is, even if a total data rate between the transmission I/F unit 146 and the reception I/F unit 107 in the subsequent stage is changed, the sampling frequency in the AD converting unit 145 is not changed.

The transmission I/F unit 146 convers the baseband reception data subjected to the AD conversion to a certain number of series of parallel data corresponding to the number of lanes set by the I/F control unit 108, and transfers the reception data to the reception I/F unit 107. At this time, the data rate of each of the lanes that operate between the transmission I/F unit 146 and the reception I/F unit 107 is the data rate set by the I/F control unit 108.

If the reception I/F unit 107 receives the reception data, the reception I/F unit 107 converts the parallel reception data into serial data, and outputs the reception data to the remote I/F terminal unit 101. Then, the remote I/F terminal unit 101 outputs the baseband reception data to the baseband processing device 10 (Step S210).

As described above, the number of lanes that operate between the interfaces for the reception data and the data rate per lane are set in accordance with the bandwidth of the reception data. Therefore, it is possible to reduce power consumption related to data transfer between the interfaces.

As described above, according to the first embodiment, a needed data rate is calculated based on the carrier bandwidth information on data, and the number of lanes between interfaces of chips that transfer each data and a data rate per lane are set to values corresponding to the minimum data rate that satisfies the needed data rate. Then, an interpolation rate and a decimation rate for DA conversion and AD conversion are determined in accordance with the number of lanes and the data rate per lane. Therefore, if the bandwidths of the transmission data and the reception data are changed, the number of lanes that operate between the chips and the data rate per lane are appropriately set in accordance with a change in the bandwidths, so that it is possible to reduce power consumption.

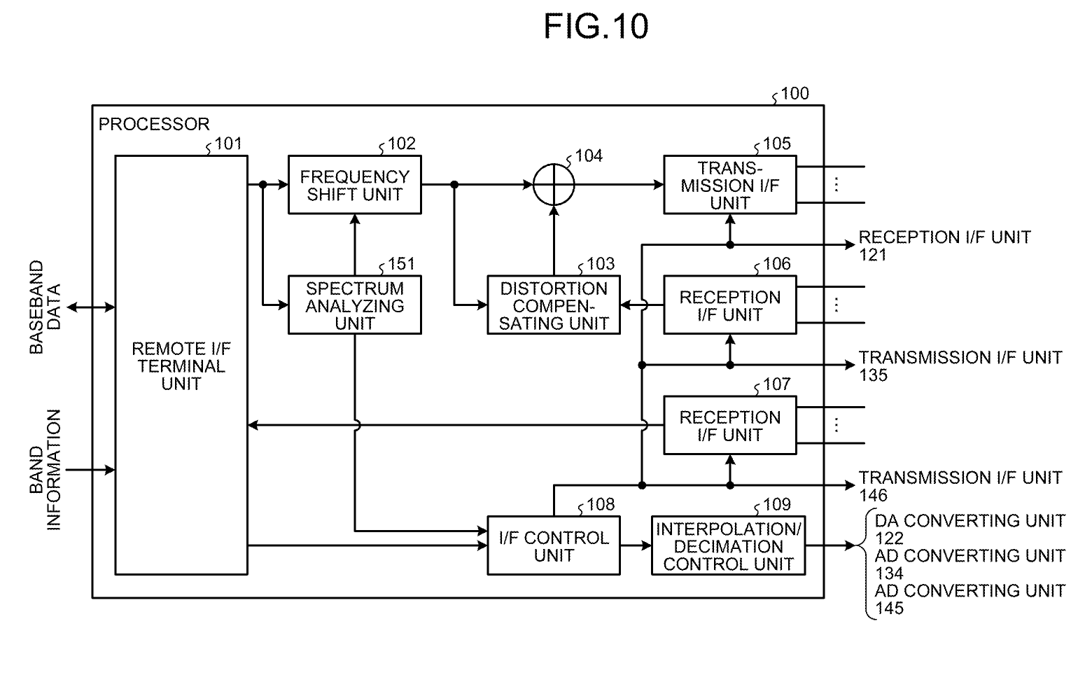

Incidentally, in the above-described first embodiment, the bandwidths of the transmission data and the reception data are acquired based on the carrier bandwidth information. However, as for the transmission data, it is possible to acquire a more precise bandwidth of the transmission data by analyzing the spectrum of the transmission data. Therefore, the wireless device 20 may include, for example, a processor 100 as illustrated in FIG. 10. The processor 100 illustrated in FIG. 10 includes a spectrum analyzing unit 151 in addition to the components of the processor 100 illustrated in FIG. 3.

The spectrum analyzing unit 151 performs, for example, fast Fourier transform (FFT) on baseband transmission data and acquires frequency band information on the transmission data. Then, the spectrum analyzing unit 151 notifies the frequency shift unit 102 of the minimum frequency and the maximum frequency of the transmission data, and notifies the I/F control unit 108 of the bandwidth of the transmission data.

The carrier bandwidth information transmitted from the baseband processing device 10 may indicate bandwidths of the transmission data and the reception data by using a plurality of carriers as a unit. In contrast, the spectrum analyzing unit 151 checks whether each of the carriers is actually used by the transmission data through a spectrum analysis. Therefore, the spectrum analyzing unit 151 can obtain detailed frequency band information on the transmission data. Then, the frequency shift unit 102 performs frequency shift and the I/F control unit 108 calculates a needed data rate on the basis of the detailed frequency band information, so that it is possible to minimize the number of lanes between the transmission I/F unit 105 and the reception I/F unit 121 and minimize the data rate per lane. As a result, it is possible to further reduce power consumption related to data transfer between the chips.

### [b] Second Embodiment

A characteristic of a second embodiment lies in that the sampling frequencies for DA conversion and AD conversion are changed in accordance with a change in the number of lanes between interfaces and the data rate per lane.

A configuration of a wireless communication system according to the second embodiment is the same as that of the first embodiment (FIG. 1), and therefore, explanation thereof will be omitted.

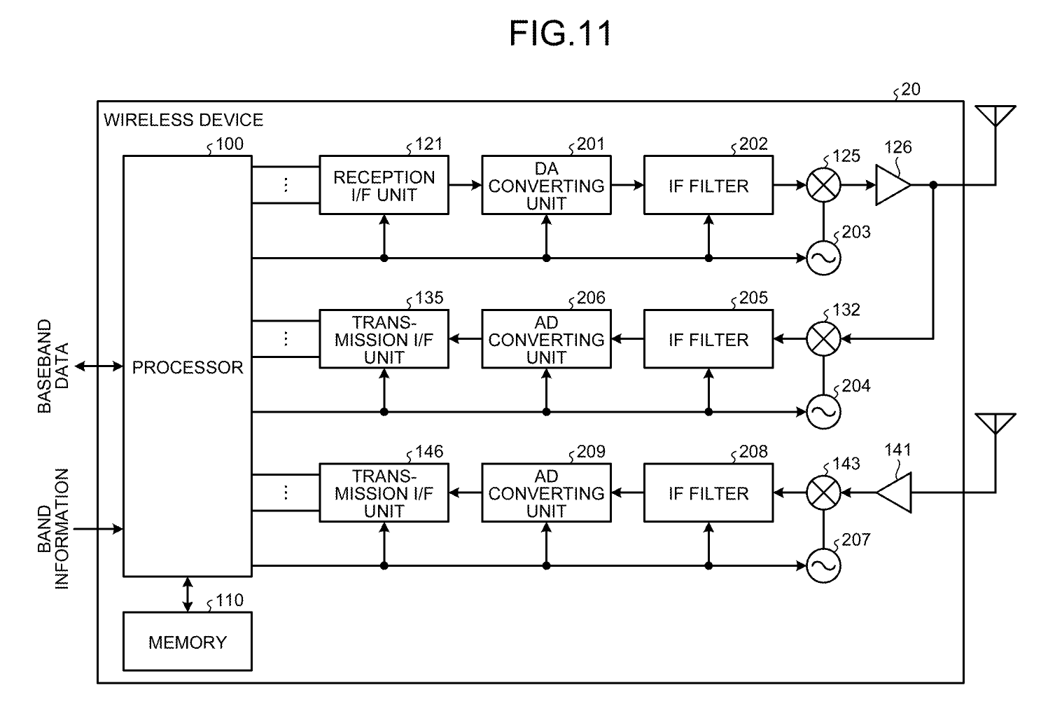

FIG. 11 is a block diagram illustrating a configuration of a wireless device 20 according to the second embodiment. In FIG. 11, the same components as those illustrated in FIG. 2 are denoted by the same reference signs, and explanation thereof will be omitted. The wireless device 20 illustrated in FIG. 11 includes a DA converting unit 201, AD converting units 206 and 209, IF filters 202, 205, and 208, and oscillators 203, 204, and 207, instead of the DA converting unit 122, the AD converting units 134 and 145, the IF filters 123, 133, and 134, and the oscillators 124, 131, and 142 illustrated in FIG. 2.

The DA converting unit 201 performs DA conversion on transmission data output from the reception I/F unit 121, and outputs transmission data at an IF to the IF filter 202. At this time, the DA converting unit 201 performs the DA conversion at a sampling frequency designated by the processor 100. Specifically, the DA converting unit 201 changes the sampling frequency in accordance with a change in the total data rate between the interfaces, which is different from the DA converting unit 122 according to the first embodiment.

The IF filter 202 is a low pass filter that has a pass band to remove an image component of the transmission data output from the DA converting unit 201 in accordance with an instruction from the processor 100. Specifically, the IF filter 202 changes the pass band to frequencies lower than a half of the sampling frequency in accordance with a change in the sampling frequency in the DA converting unit 201, and removes an image component generated in frequencies equal to or higher than the half of the sampling frequency.

The oscillator 203 generates a local signal for performing up-conversion on the transmission data at the IF to transmission data an RF. At this time, the oscillator 203 adjusts the frequency of the local signal in accordance with a change in the sampling frequency in the DA converting unit 201 such that the transmission data is converted to transmission data at an RF in a specified frequency band through the up-conversion.

The oscillator 204 generates a local signal for performing down-conversion on the transmission data at the RF to transmission data at an IF. At this time, the oscillator 204 adjusts the frequency of the local signal in accordance with a change in the sampling frequency in the AD converting unit 206 to be described later such that feedback data is converted to feedback data at an IF in a desired frequency band through the down-conversion.

The IF filter 205 is a low pass filter that has a pass band to remove folding noise in the feedback data in accordance with an instruction from the processor 100. Specifically, the IF filter 205 changes the pass band to frequencies lower than a half of the sampling frequency in accordance with a change in the sampling frequency in the AD converting unit 206, and removes, from the feedback data, a component in frequencies equal to or higher than the half of the sampling frequency.

The AD converting unit 206 performs AD conversion on the feedback data output from the IF filter 205, and outputs baseband feedback data to the transmission I/F unit 135. At this time, the AD converting unit 206 performs the AD conversion at the sampling frequency designated by the processor 100. That is, the AD converting unit 206 changes the sampling frequency in accordance with a change in the total data rate between the interfaces, instead of the AD converting unit 134 according to the first embodiment.

The oscillator 207 generates a local signal for performing down-conversion on the reception data at an RF to reception data at an IF. At this time, the oscillator 207 adjusts the frequency of the local signal in accordance with a change in the sampling frequency in the AD converting unit 209 to be described later such that the reception data is converted to reception data at an IF in a desired frequency band through the down-conversion.

The IF filter 208 is a low pass filter that has a pass band to remove folding noise in the reception data in accordance with an instruction from the processor 100. Specifically, the IF filter 208 changes the pass band to frequencies lower than a half of the sampling frequency in accordance with a change in the sampling frequency in the AD converting unit 209 to be described later, and removes, from the reception data, a component in frequencies equal to or higher than the half of the sampling frequency.

The AD converting unit 209 performs AD conversion on the reception data output from the IF filter 208, and outputs baseband reception data to the transmission I/F unit 146. At this time, the AD converting unit 209 performs the AD conversion at the sampling frequency designated by the processor 100. That is, the AD converting unit 209 changes the sampling frequency in accordance with a change in the total data rate between the interfaces, instead of the AD converting unit 145 according to the first embodiment.

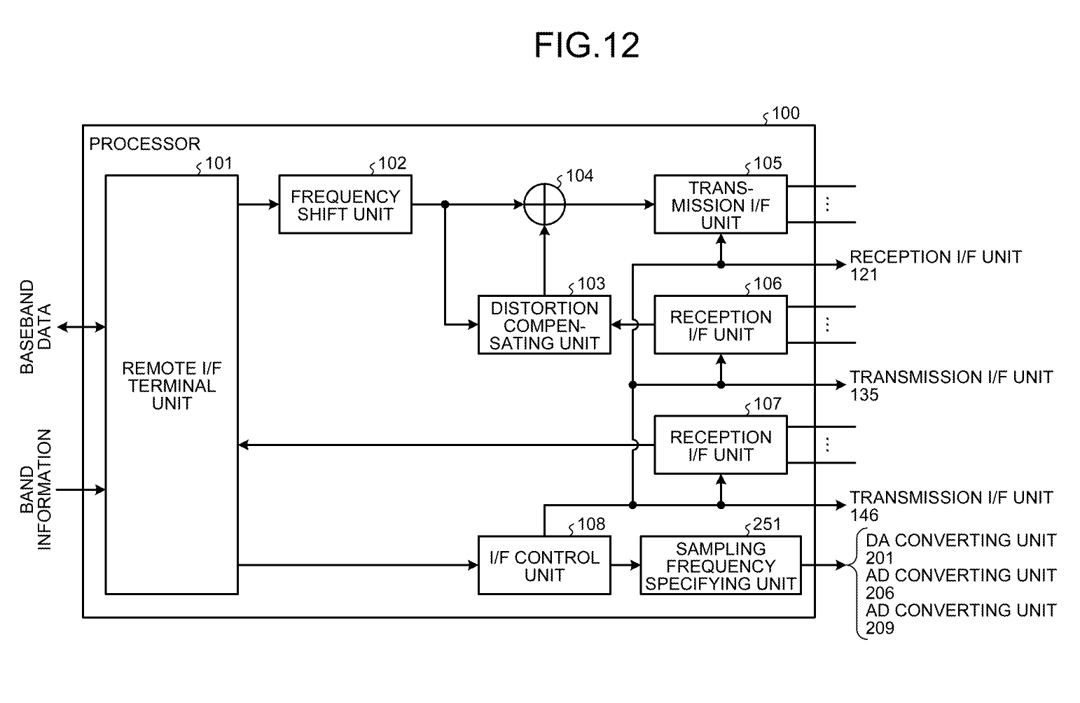

FIG. 12 is a block diagram illustrating a configuration of a processor 100 according to the second embodiment. In FIG. 12, the same components as those illustrated in FIG. 3 are denoted by the same reference signs, and explanation thereof will be omitted. The processor 100 illustrated in FIG. 12 includes a sampling frequency specifying unit 251, instead of the interpolation/decimation control unit 109 of the processor 100 illustrated in FIG. 3.

The sampling frequency specifying unit 251 determines the sampling frequencies for DA conversion and AD conversion in accordance with a total data rate obtained by the number of lanes that operate between the interfaces and a data rate per lane. Specifically, when the I/F control unit 108 changes the number of operating lanes or the like, the total data rate for transfer between the interfaces is changed, and therefore, the sampling frequency specifying unit 251 determines the sampling frequencies for DA conversion and AD conversion in accordance with a change in the data rate.

Therefore, for example, if the total data rate between the interfaces for transmission data is large, the sampling frequency specifying unit 251 increases the sampling frequency in the DA converting unit 201 in conformity with the data rate. In contrast, for example, if the total data rate between the interfaces for transmission data is small, the sampling frequency specifying unit 251 reduces the sampling frequency in the DA converting unit 201 in order to reduce power consumption.

Similarly, for example, if the total data rate between the interfaces for reception data is large, the sampling frequency in the AD converting unit 209 is increased in conformity with the data rate. Furthermore, for example, if the total data rate between the interfaces for reception data is small, the sampling frequency in the AD converting unit 209 is reduced in order to reduce power consumption.

Moreover, the sampling frequency specifying unit 251 determines pass bands of the IF filters 202, 205, and 208 in accordance with a change in the sampling frequencies in the DA converting unit 201 and the AD converting units 206 and 209, and notifies the IF filters of the pass bands. Similarly, the sampling frequency specifying unit 251 determines frequencies of local signals in the oscillators 203, 204, and 207 in accordance with a change in the sampling frequencies, and notifies the oscillators of the frequencies.

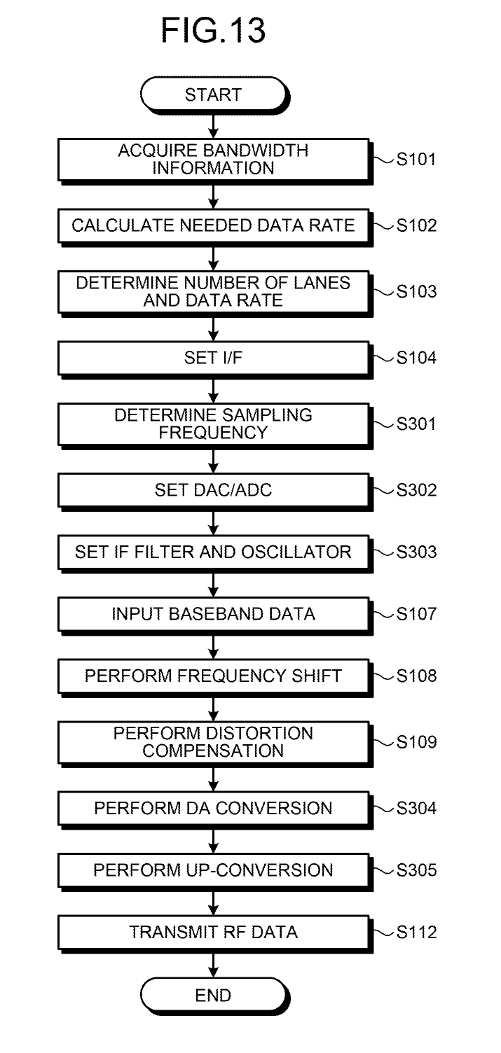

A process performed by the wireless device 20 with the above-described configuration at the time of transmitting data will be described below with reference to a flowchart illustrated in FIG. 13. In FIG. 13, the same processes as those illustrated in FIG. 4 are denoted by the same step numbers, and detailed explanation thereof will be omitted. Furthermore, in FIG. 13, operation related to feedback of transmission data is omitted.

The remote I/F terminal unit 101 acquires carrier bandwidth information indicating a band of transmission data from the baseband processing device 10 (Step S101) and outputs the carrier bandwidth information to the I/F control unit 108, and the I/F control unit 108 calculates needed data rates of the transmission data and feedback data (Step S102). Upon calculating the needed data rates, the I/F control unit 108 determines the number of lanes between the interfaces and a data rate of each of the lanes so as to satisfy the needed data rates (Step S103). Then, the number of lanes and the data rate per lane determined as above are set in each of the interfaces (Step S104).

Furthermore, the sampling frequency specifying unit 251 determines sampling frequencies in the DA converting unit 201 and the AD converting unit 206 from a data rate corresponding to the combination of the number of lanes and the data rate per lane (Step S301). In the second embodiment, if the data rate between the interfaces is small, it is possible to reduce the sampling frequencies in the DA converting unit 201 and the AD converting unit 206 in accordance with the data rate, so that it is possible to reduce power consumption related to DA conversion and AD conversion.

The sampling frequency specifying unit 251 sets the determined sampling frequencies in the DA converting unit 201 and the AD converting unit 206 (Step S302). As described above, the sampling frequencies for DA conversion and AD conversion are set in accordance with the data rate between the interfaces, so that the sampling frequencies in the DA converting unit 201 and the AD converting unit 206 are changed. Therefore, the sampling frequency specifying unit 251 sets pass bands corresponding to the sampling frequencies such that the IF filters 202 and 205 can pass appropriate bands even when the sampling frequencies are changed. Furthermore, the frequency of the transmission data is also changed in accordance with a change in the sampling frequencies. Therefore, the sampling frequency specifying unit 251 adjusts frequencies of local signals generated by the oscillators 203 and 204 (Step S303). With the setting in the IF filters 202 and 205 and the oscillators 203 and 204, it is possible to prevent out-of-band emission even when the sampling frequencies are changed.

Then, in the state in which the number of lanes between the interfaces, the data rate per lane, and the sampling frequencies for DA conversion and AD conversion are set, baseband transmission data is input to the remote I/F terminal unit 101 of the processor 100 (Step S107). The remote I/F terminal unit 101 outputs the transmission data to the frequency shift unit 102, and the frequency shift unit 102 performs frequency shift such that the center frequency becomes 0 Hz (Step S108).

The synthesizing unit 104 performs distortion compensation on the transmission data subjected to the frequency shift (Step S109). The transmission I/F unit 105 converts the transmission data subjected to the distortion compensation into a certain number of series of parallel data corresponding to the number of lanes set by the I/F control unit 108, and transfers the transmission data to the reception I/F unit 121. At this time, the data rate of each of the lanes that operate between the transmission I/F unit 105 and the reception I/F unit 121 is the data rate set by the I/F control unit 108.

If the reception I/F unit 121 receives the transmission data, the reception I/F unit 121 converts the parallel transmission data into serial data, and outputs the transmission data to the DA converting unit 201. Then, the DA converting unit 201 performs DA conversion on the transmission data (Step S304). The DA converting unit 201 performs the DA conversion at the sampling frequency set by the sampling frequency specifying unit 251. Therefore, if a total data rate between the transmission I/F unit 105 and the reception I/F unit 121 is changed, the sampling frequency in the DA converting unit 201 is changed in accordance with the change, so that power consumption related to the DA conversion can be reduced.

The transmission data subjected to the DA conversion passes through the IF filter 202, so that an image component is removed. The pass band of the IF filter 202 is changed in accordance with a change in the sampling frequency in the DA converting unit 201, and the image component is removed with accuracy. Then, the mixer 125 performs up-conversion on the transmission data that has passed through the IF filter 202 (Step S305). At this time, the frequency of the local signal generated by the oscillator 203 is adjusted in accordance with the sampling frequency in the DA converting unit 201. Therefore, if the mixer 125 converts the transmission data to data at an RF, transmission data in a specified frequency band is obtained.

The transmission data at the RF subjected to the up-conversion is amplified by the amplifier 126, and then wirelessly transmitted from the antenna (Step S112). Thereafter, the transmission data is fed back as feedback data, and the sampling frequency for AD conversion on the feedback data is changed in accordance with a total data rate between the transmission I/F unit 135 and the reception I/F unit 106. Therefore, if the total data rate is small, the sampling frequency in the AD converting unit 206 is reduced and the power consumption related to the AD conversion is reduced.

As described above, the number of lanes that operate between the interfaces for the transmission data and the feedback data and the data rate per lane are set in accordance with the bandwidth of the transmission data, and the sampling frequencies for DA conversion and AD conversion are changed in accordance with the data rate. Therefore, it is possible to reduce power consumption related to DA conversion and AD conversion as well as power consumption related to data transfer between the interfaces. While the process at the time of transmitting data has been described above, a process at the time of receiving data is the same as the process at the time of transmitting data, and it is possible to reduce power consumption related to AD conversion as well as power consumption related to data transfer.

As described above, according to the second embodiment, a needed data rate is calculated based on the carrier bandwidth information on data, and the number of lanes between interfaces of chips that transfer each data and a data rate per lane are set to values corresponding to the needed data rate. Then, the sampling frequencies for DA conversion and AD conversion are determined in accordance with the number of lanes and the data rate per lane. Therefore, if the bandwidths of the transmission data and the reception data are changed, not only the number of lanes that operate between the chips and the data rate per lane, but also the sampling frequencies for DA conversion and AD conversion are appropriately set in accordance with a change in the bandwidths, so that it is possible to reduce power consumption.

Furthermore, even if the sampling frequencies for DA conversion and AD conversion are changed, because the pass band of the IF filter and the frequency of a local signal generated by the oscillator are adjusted, it is possible to prevent an unwanted band component from remaining and prevent out-of-band emission from occurring.

Incidentally, in the above-described embodiments, it may be possible to control a timing of changing the number of lanes and the data rate per lane in each of the interfaces, and may change the number of lanes and the like at a timing at which each of the interfaces is not used. Specifically, if the wireless device 20 is provided in a wireless communication system using a time division duplex (TDD) scheme, it may be possible to change the number of lanes and the like between the transmission I/F unit 146 and the reception I/F unit 107 for reception data at the time of performing down communication for transmitting transmission data. Similarly, it may be possible to change the number of lanes and the like between the transmission I/F units 105, 135 and the reception I/F units 121, 106 for transmission data and feedback data at the time of performing uplink communication for receiving reception data.

According to an embodiment of the wireless device and the data transfer method of the disclosed technology, it is possible to reduce power consumption.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless device comprising:
a processor that includes a first interface for transmitting and receiving data;
a second interface that transfers data to and from the first interface; and
a memory connected to the processor, wherein
the processor executes a process including:
acquiring carrier bandwidth information on baseband data used for wireless communication;
calculating a needed data rate for transferring the baseband data between the first interface and the second interface, based on the acquired carrier bandwidth information;
determining number of transfer paths for simultaneously transferring the baseband data between the first interface and the second interface, based on the calculated needed data rate; and
causing the first interface and the second interface to transmit and receive the baseband data by simultaneously using the determined number of transfer paths.

2. The wireless device according to claim 1, wherein the determining includes determining a data rate per transfer path.

3. The wireless device according to claim 1, wherein
the processor further executes a process including:
acquiring the baseband data; and
performing frequency shift to set a center frequency of the acquired baseband data to zero, and
the causing includes causing the first interface to transmit the baseband data subjected to the frequency shift.

4. The wireless device according to claim 1, further comprising:
a digital-to-analog (DA) converter that is connected to the second interface and that performs DA conversion on baseband data received by the second interface, wherein
the processor further executes a process including:
determining an interpolation rate in the DA converter in accordance with the determined number of transfer paths; and
causing the DA converter to perform DA conversion with interpolation of the baseband data at the determined interpolation rate.

5. The wireless device according to claim 1, further comprising:
an analog-to-digital (AD) converter that is connected to the second interface and that outputs, to the second interface, baseband data obtained through AD conversion on analog data, wherein
the processor further executes a process including:
determining a decimation rate in the AD converter in accordance with the determined number of transfer paths; and
causing the AD converter to perform AD conversion with decimation of the analog data at the determined decimation rate.

6. The wireless device according to claim 1, further comprising:
a digital-to-analog (DA) converter that is connected to the second interface and that performs DA conversion on baseband data received by the second interface, wherein
the processor further executes a process including:
determining a sampling frequency in the DA converter in accordance with the determined number of transfer paths; and
causing the DA converter to perform DA conversion on the baseband data at the determined sampling frequency.

7. The wireless device according to claim 6, further comprising:
a filter that passes analog data output from the DA converter; and
a mixer that converts a frequency of the analog data that has passed through the filter to a radio frequency by using a local signal, wherein
the processor further executes a process including changing a band to be removed from the analog data by the filter and changing a frequency of the local signal used by the mixer, in accordance with the determined sampling frequency.

8. The wireless device according to claim 1, further comprising:
an analog-to-digital (AD) converter that is connected to the second interface and that outputs, to the second interface, baseband data obtained through AD conversion on analog data, wherein
the processor further executes a process including:
determining a sampling frequency in the AD converter in accordance with the determined number of transfer paths; and
causing the AD converter to perform AD conversion on the analog data at the determined sampling frequency.

9. The wireless device according to claim 8, further comprising:
a mixer that converts analog data at a radio frequency to analog data at an intermediate frequency by using a local signal; and
a filter that passes the analog data converted to the intermediate frequency by the mixer, wherein
the processor further executes a process including changing a frequency of the local signal used by the mixer and changing a frequency component to be removed from the analog data by the filter, in accordance with the determined sampling frequency.

10. The wireless device according to claim 1, wherein the acquiring includes analyzing a spectrum of the baseband data, and acquiring the carrier bandwidth information on the baseband data from a result of analysis of the spectrum.

11. A data transfer method implemented between a plurality of interfaces included in a wireless device, the data transfer method comprising:
acquiring carrier bandwidth information on baseband data used for wireless communication;
calculating a needed data rate for transferring the baseband data between the interfaces, based on the acquired carrier bandwidth information;
determining number of transfer paths for simultaneously transferring the baseband data between the interfaces, based on the calculated needed data rate; and
transmitting and receiving the baseband data between the interfaces by simultaneously using the determined number of transfer paths.
